(19) United States
(12) Patent Application Publication
(10) Pub. No.: US 2025/0148293 A1
(43) Pub. Date: May 8, 2025

(54) MULTI-SOURCE DOMAIN ADAPTATION VIA PROMPT-BASED META-LEARNING

(71) Applicant: NEC Laboratories America, Inc., Princeton, NJ (US)

(72) Inventors: Junxiang Wang, Plainsboro, NJ (US); Wei Cheng, Princeton Junction, NJ (US); Haifeng Chen, West Windsor, NJ (US)

(21) Appl. No.: 18/934,676

(22) Filed: Nov. 1, 2024

Related U.S. Application Data
(60) Provisional application No. 63/595,904, filed on Nov. 3, 2023.

(51) Int. Cl. G06N 3/094

(52) U.S. Cl. CPC G06N 3/094

(57) ABSTRACT

Methods and systems include adapting an initial prompt to a target domain corresponding to an input time series to generate an adapted prompt. The adapted prompt and the input time series are combined. The input time series is processed with the adapted prompt using a modular transformer encoder that has a plurality of sub-encoders, with a policy network selecting a subset of the plurality of encoders that are applied to the input time series and the adapted prompt.

### RELATED APPLICATION INFORMATION

This application claims priority to U.S. Patent Application No. 63/595,904, filed on Nov. 3, 2023, incorporated herein by reference in its entirety.

### BACKGROUND

### Technical Field

The present invention relates to machine learning models and, more particularly, to modular multi-domain models.

### Description of the Related Art

Machine learning models, such as large language models, are trained on large sets of data. The independence and identically distributed assumption underlies this training, with a reliance on the idea that every data point within a sample maintains its independence from other data points, even as they are drawn from the same probability distribution. However, this assumption faces challenges in time series due to the presence of domain shifts.

A domain shift in time series data refers to situations where there are discernible changes in data distribution from one time to another. As one transitions from one domain (e.g., one time period or segment from the time series) to another, the statistical characteristics, patterns, and features of the data may change. This may include temporal shifts (e.g., seasonal shifts) and spatial shifts (e.g., epidemiological differences between countries).

### SUMMARY

A method includes adapting an initial prompt to a target domain corresponding to an input time series to generate an adapted prompt. The adapted prompt and the input time series are combined. The input time series is processed with the adapted prompt using a modular transformer encoder that has a plurality of sub-encoders, with a policy network selecting a subset of the plurality of encoders that are applied to the input time series and the adapted prompt.

A system includes a hardware processor and a memory that stores a computer program. When executed by the hardware processor, the computer program causes the hardware processor to adapt an initial prompt to a target domain corresponding to an input time series to generate an adapted prompt, to combine the adapted prompt and the input time series, and to process the input time series with the adapted prompt using a modular transformer encoder that has a plurality of sub-encoders, with a policy network selecting a subset of the plurality of encoders that are applied to the input time series and the adapted prompt.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram illustrating the effect that different domains of a system may have on different time series measurements of the system, in accordance with an embodiment of the present invention;

FIG. 2 is a block diagram illustrating how a mixture of expert models can be used to provide a time-series-based prediction across multiple domains, in accordance with an embodiment of the present invention;

FIG. 3 is a block/flow diagram of an expert model that includes a modular transformer encoder, in accordance with an embodiment of the present invention;

FIG. 4 is block diagram of a modular transformer encoder that is configured by a policy network responsive to a target domain, in accordance with an embodiment of the present invention;

FIG. 5 is a block/flow diagram of a method for adapting a prompt to handle a target domain, in accordance with an embodiment of the present invention;

FIG. 6 is a block diagram of a computing device that can perform prompt adaptation to perform anomaly detection in varying domains, in accordance with an embodiment of the present invention;

FIG. 7 is a diagram of an exemplary neural network architecture that can be used to implement part of a modular transformer encoder, in accordance with an embodiment of the present invention; and

FIG. 8 is a diagram of an exemplary deep neural network architecture that can be used to implement part of a modular transformer encoder, in accordance with an embodiment of the present invention.

### DETAILED DESCRIPTION OF PREFERRED EMBODIMENTS

To address the complications that arise from domain shifts, prompt engineering may be applied to provide domain adaptation in the context of large language models (LLMs) and natural language processing (NLP) generally. Prompt learning provides specific cues or instructions to guide its outputs according to a present domain. Applying prompt learning to time-series data can help retain domain-specific knowledge.

In particular, a modular model is trained to handle time-series data, with a meta-prompt-based modular network model using a mixture of experts (MoE) approach to combine multiple time-series expert models through weighted aggregation. Rather than treating the prompt as independent for each source time-series domain, it may be treated as a shared hyperparameter. The prompt is thus learned using a Reptile-based meta-learning approach. The learned prompt can then be adapted to the target domain for the time-series data input using few-shot learning.

The model is trained using a modular autoencoder structure, with a collection of sub-encoders being selectable by a policy network to adapt the model to a particular domain. This selection of sub-encoders is guided by few-shot learning based on a small number of examples from the target domain. Furthermore multiple time-series expect models may be used together with a weighted aggregation to improve the accuracy of the model's output.

Referring now to FIG. 1, an example of domain shift is shown. Two domains are illustrated as temperatures during the summer season 102 and temperatures during the winter season 104. Respective time series showing temperature measurements in these two domains are shown, including warmer temperatures 106 and colder temperatures 108. A model that is trained on data 106 from the summer season 102 will provide less accurate results when provided with input data 108 form the winter season 104.

Although this example uses changing seasons as an example of different domains, it should be understood that the term “domain” as used herein may refer to any relatively stable state for a system. Examples of different domains in the context of a computer network may reflect whether the load reflects peak usage or a relatively low-usage state, whether a computer processor is under heavy load or is idle, and whether a given service is enabled or disabled. A domain may represent any of a set of discrete operational states of a system. In some cases the domain may be relatively stable as compared to a period of measurement of time-series data, so that the system is likely to remain in a given domain across many such measurements.

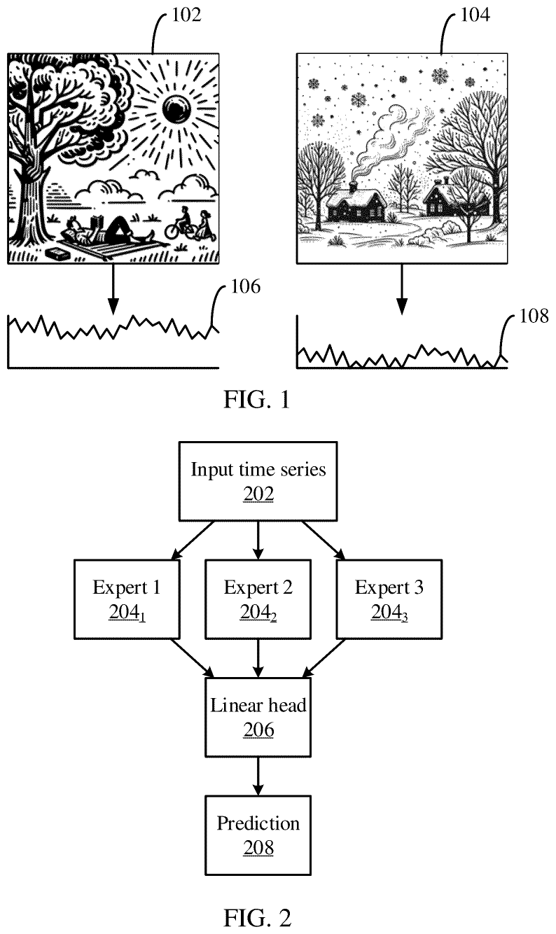

Referring now to FIG. 2, a diagram of an MoE model architecture is shown. An input time series 202 is provided to each of a set of expert models 204n, with each being implemented as, e.g., a patch time series transformer model. The expert models 204n provide patching and channel independence. Patching involves aggregating time series into subseries-level patches to capture comprehensive semantic information. Channel independences signifies that each input token includes information from a distinct channel. Each univariate time series within a channel undergoes an instance normalization, followed by segmentation into patches. These patches are subsequently used as input tokens for a transformer encoder. A representation of the time series is generated using the transformer encoder and linear heads. The outputs of the experts 204n are combined at a linear head 206 which performs a weighted aggregation to produce a prediction 208.

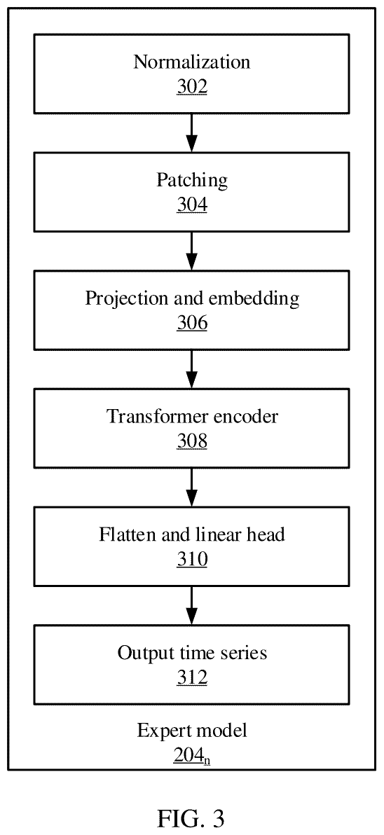

Referring now to FIG. 3, additional detail on one of the expert models 204n is shown. The input univariate time series xᵢ passes through normalization 302 before being patched 304 into subseries-level patches. The individual patches then go through projection and embedding 306. Taken together, blocks 302, 304, and 306 are represented herein by the function g₁.

A transformer encoder 308 processes the patch embeddings, and the output of the transformer encoder 308 goes through flattening and a linear head at 310 to produce an output time series 312. Taken together, blocks 308 and 310 are represented herein by the function g₂. Thus the output of the i^{th} expert model 204; is zᵢ=g(xᵢ, n)=g₂ (g₁ (xᵢ)), where η is a set of parameters of the expert model. Given outputs of all N expert models, a weight W is used to learn routing. W determines which expert's output is more important to model prediction. Specifically, the logit of the i^{th} expert is h(zᵢ)=Wzᵢ, so the logit is transformed to a probability distribution by the softmax function:

$$p ( {z}_{i} ) = \frac{{e}^{h ( {z}_{i} )}}{{\sum }_{i} {e}^{h ( {z}_{i} )}}$$

where p(zᵢ) is the probability of the iₜₕ expert. The final output is:

$$y = {\sum }_{i} {p}_{i} ( {z}_{i} ) {z}_{i}$$

which is a weighted aggregation of all expert outputs.

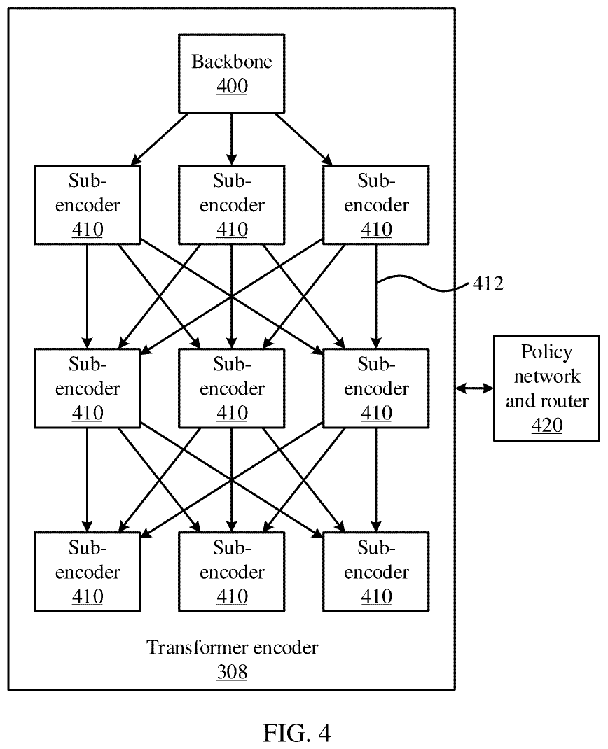

Referring now to FIG. 4, additional detail on the transformer encoder 308 is shown. The transformer encoder 308 is made up of a backbone network 400 and a set of sub-encoders 410. These sub-encoders are connected to one another by paths 412. The paths are selectively activated by a policy network and router 420. Thus each of the experts 204, has its own respective modular transformer encoder 308 with its own respective policy network and router 420.

The policy network and router 420 selects path in accordance with a domain of the input data, thereby selecting the sub-encoders 410 which process that input data. During pre-training of the transformer encoder 308, the policy network and router 420 is trained jointly with the sub-encoders 410 and the backbone 400 to provide modular domain-specific training. During operation, any given input activates a particular path through the sub-encoders 410 to generate an output.

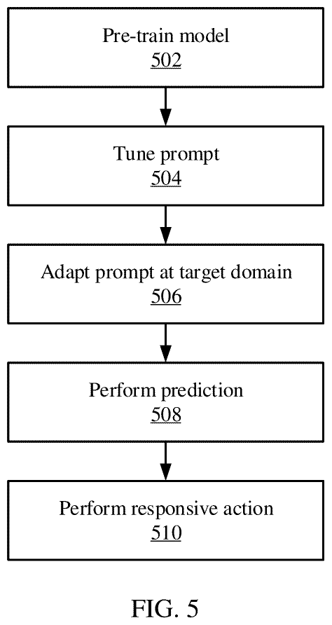

Referring now to FIG. 5, a method of training and using a model with domain adaptation is shown. Block 502 pre-trains the model for a predetermined set of source domains, with respective batches of domain-specific training data. Block 504 then performs prompt tuning, to learn the prompt as a common hyperparameter for each time series source domain. This can be performed using Reptile-based meta-learning.

Block 506 then adapts the prompt for a target domain based on a given input time series. Using the prompt to guide the model to a corresponding domain, block 508 performs prediction using the input time series, for example classifying the input time series or predicting future events. Block 510 can then perform an action responsive to the prediction. For example, the prediction may relate to a variety of different fields where data may reflect different domains, such as human activity recognition, sleep stage classification, and system anomaly detection.

In prompt tuning 504, a prompt P may be concatenated to the input time series patches g₁ (xᵢ) and used as the input to g₂, as g₂ ([g₁ (xᵢ), P]). The prompt P may be shared for all source time-series domains. Prompt tuning may be performed with a function ƒ₂(g₂ ([g₁ (xᵢ), P]), θ₂) for fixed parameters θ₂ in the model.

The prompt tuning 504 may initialize a soft prompt P, a number of source domains T, a number of global steps N, a global learning rate E, and a local learning rate η. The tuning may then iteratively sample a task t ∈ [N] and perform stochastic gradient descent for k steps on task t's loss Lₜ, starting with P to produce Qₜ. At each iteration, the prompt P is updated as P=P+∈(Qₜ−P). The prompt P may then be adapted to target domains in block 506 by few-shot learning in the target domain, with a relatively small number of labeled data samples in the target domain. During prediction 508, the prompt P is appended to the input time series as if it were additional time segments to provide information to the model.

In an example, the time series may be derived from a sensor in a cyber-physical system, monitoring the operational and/or environmental conditions of the system. For example, the sensor may monitor a factory or other industrial site and may monitor information such as temperature, humidity, vibration, chemical exposure, and any other appropriate quantity that may vary over time. In another example, the sensor may monitor the operation of a networked computer system, and may collect information on operational status such as processor load, memory usage, I/O usage, bandwidth usage, and any other appropriate quantity that may vary over time.

In such examples, the transformer encoder 308 may be trained to detect anomalous behavior that diverges from the expected behavior of the system. Such behavior may represent a change in the operating conditions or environment. Another use is to predict future problems, such as when the present conditions indicate a potentially dangerous or broken operational state. The responsive action 510 may therefore be implemented automatically to mitigate the hazard and prevent further damage.

Thus the responsive action 510 may include a change to an environmental or operational state of the system. Examples of changes to the environmental state include changing parameters of a climate control system to change a temperature or humidity level or to engage a fire suppression system. Examples of changes to the operational state include turning a machine or computer on or off or changing a configuration of such a device, for example altering the network management policies for a networked computer system or changing a security level.

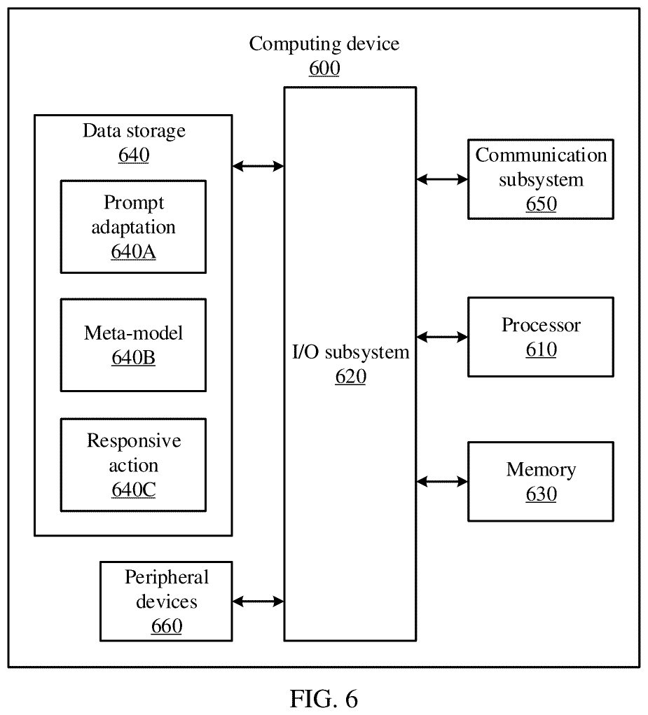

Referring now to FIG. 6, an exemplary computing device 600 is shown, in accordance with an embodiment of the present invention. The computing device 600 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 600 may be embodied as one or more compute sleds, memory sleds, or other racks, sleds, computing chassis, or other components of a physically disaggregated computing device.

As shown in FIG. 6, the computing device 600 illustratively includes the processor 610, an input/output subsystem 620, a memory 630, a data storage device 640, and a communication subsystem 650, and/or other components and devices commonly found in a server or similar computing device. The computing device 600 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 630, or portions thereof, may be incorporated in the processor 610 in some embodiments.

The processor 610 may be embodied as any type of processor capable of performing the functions described herein. The processor 610 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 630 may be embodied as any type of volatile or non-volatile memory or data storage capable of performing the functions described herein. In operation, the memory 630 may store various data and software used during operation of the computing device 600, such as operating systems, applications, programs, libraries, and drivers. The memory 630 is communicatively coupled to the processor 610 via the I/O subsystem 620, which may be embodied as circuitry and/or components to facilitate input/output operations with the processor 610, the memory 630, and other components of the computing device 600. For example, the I/O subsystem 620 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 620 may form a portion of a system-on-a-chip (SOC) and be incorporated, along with the processor 610, the memory 630, and other components of the computing device 600, on a single integrated circuit chip.

The data storage device 640 may be embodied as any type of device or devices configured for short-term or long-term storage of data such as, for example, memory devices and circuits, memory cards, hard disk drives, solid state drives, or other data storage devices. The data storage device 640 can store program code 640A for prompt adaptation, 640B for implementing a modular meta-model, and/or 640C for performing a responsive action based on the model's output. Any or all of these program code blocks may be included in a given computing system. The communication subsystem 650 of the computing device 600 may be embodied as any network interface controller or other communication circuit, device, or collection thereof, capable of enabling communications between the computing device 600 and other remote devices over a network. The communication subsystem 650 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 600 may also include one or more peripheral devices 660. The peripheral devices 660 may include any number of additional input/output devices, interface devices, and/or other peripheral devices. For example, in some embodiments, the peripheral devices 660 may include a display, touch screen, graphics circuitry, keyboard, mouse, speaker system, microphone, network interface, and/or other input/output devices, interface devices, and/or peripheral devices.

Of course, the computing device 600 may also include other elements (not shown), as readily contemplated by one of skill in the art, as well as omit certain elements. For example, various other sensors, input devices, and/or output devices can be included in computing device 600, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 600 are readily contemplated by one of ordinary skill in the art given the teachings of the present invention provided herein.

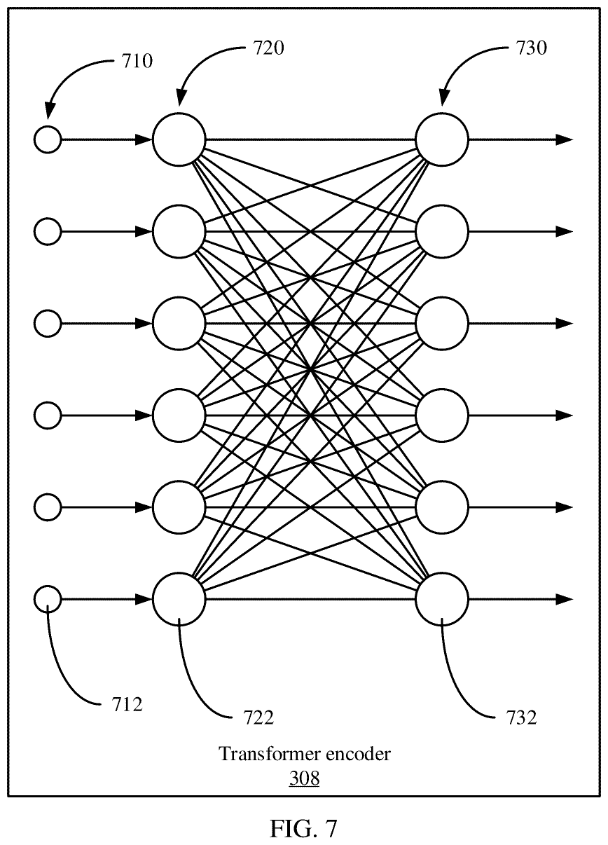

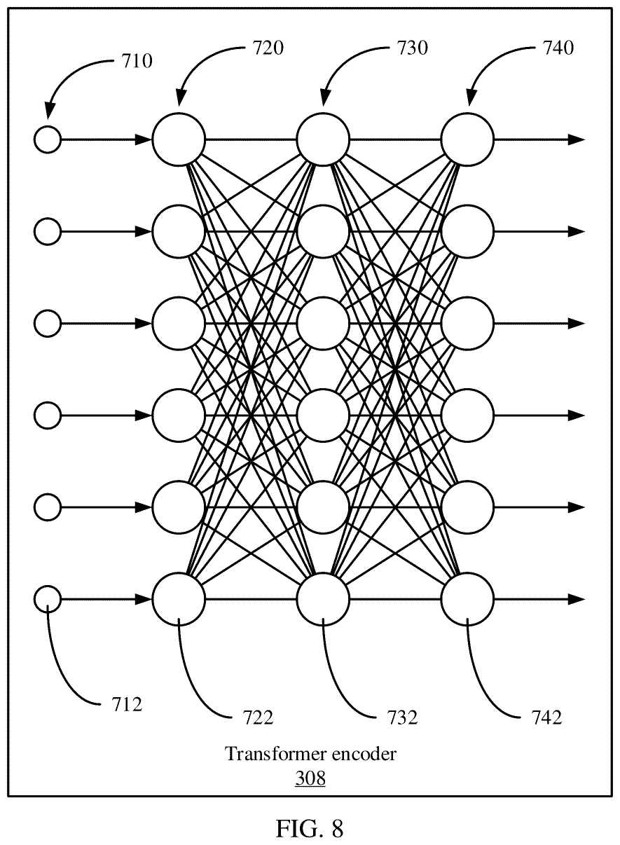

Referring now to FIGS. 7 and 8, exemplary neural network architectures are shown, which may be used to implement parts of the present models, such as the transformer encoder 308. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 720 of source nodes 722, and a single computation layer 730 having one or more computation nodes 732 that also act as output nodes, where there is a single computation node 732 for each possible category into which the input example could be classified. An input layer 720 can have a number of source nodes 722 equal to the number of data values 712 in the input data 710. The data values 712 in the input data 710 can be represented as a column vector. Each computation node 732 in the computation layer 730 generates a linear combination of weighted values from the input data 710 fed into input nodes 720, and applies a non-linear activation function that is differentiable to the sum. The exemplary simple neural network can perform classification on linearly separable examples (e.g., patterns).

A deep neural network, such as a multilayer perceptron, can have an input layer 720 of source nodes 722, one or more computation layer(s) 730 having one or more computation nodes 732, and an output layer 740, where there is a single output node 742 for each possible category into which the input example could be classified. An input layer 720 can have a number of source nodes 722 equal to the number of data values 712 in the input data 710. The computation nodes 732 in the computation layer(s) 730 can also be referred to as hidden layers, because they are between the source nodes 722 and output node(s) 742 and are not directly observed. Each node 732, 742 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method, comprising:
adapting an initial prompt to a target domain corresponding to an input time series to generate an adapted prompt;
combining the adapted prompt and the input time series; and
processing the input time series with the adapted prompt using a modular transformer encoder that has a plurality of sub-encoders, with a policy network selecting a subset of the plurality of encoders that are applied to the input time series and the adapted prompt.

2. The method of claim 1, wherein combining the adapted prompt and the input time series includes appending the adapted prompt to the input time series as additional time series segments.

3. The method of claim 1, further comprising learning the initial prompt based on a plurality of training datasets from respective source domains.

4. The method of claim 3, further comprising training the transformer encoder on the plurality of training datasets along with the policy network so that the policy network learns sub-encoders associated with different respective source domains.

5. The method of claim 1, wherein the adapting, combining, and processing is performed in a first expert model, and is performed in parallel in at least one additional expert model using one or more respective additional modular transformer encoders.

6. The method of claim 5, further comprising combining outputs of the first expert model and the at least one additional expert model with a linear head to generate a prediction.

7. The method of claim 1, wherein the policy network is trained to configure routing between the plurality of encoders responsive to a plurality of different domains.

8. The method of claim 7, wherein the target domain is one of a plurality of discrete operational states of a system.

9. The method of claim 1, further comprising:
detecting an anomaly in a system that originates the input time series based on an output of the modular transformer encoder; and
performing an action in the system to correct the anomaly.

10. The method of claim 9, wherein the action is selected from the group consisting of changing parameters of a climate control system to change a temperature or humidity level, engaging a fire suppression system, turning a machine or computer on or off, and changing a configuration of such a computer.

11. A system, comprising:
a hardware processor; and
a memory that stores a computer program which, when executed by the hardware processor, causes the hardware processor to:
adapt an initial prompt to a target domain corresponding to an input time series to generate an adapted prompt;
combine the adapted prompt and the input time series; and
process the input time series with the adapted prompt using a modular transformer encoder that has a plurality of sub-encoders, with a policy network selecting a subset of the plurality of encoders that are applied to the input time series and the adapted prompt.

12. The system of claim 11, wherein the combination of the adapted prompt and the input time series includes appending the adapted prompt to the input time series as additional time series segments.

13. The system of claim 11, wherein the computer program further causes the hardware processor to learn the initial prompt based on a plurality of training datasets from respective source domains.

14. The system of claim 13, wherein the computer program further causes the hardware processor to train the transformer encoder on the plurality of training datasets along with the policy network so that the policy network learns sub-encoders associated with different respective source domains.

15. The system of claim 11, wherein the adaptation, combination, and processing is performed in a first expert model, and is performed in parallel in at least one additional expert model using one or more respective additional modular transformer encoders.

16. The system of claim 15, wherein the computer program further causes the hardware processor to combine outputs of the first expert model and the at least one additional expert model with a linear head to generate a prediction.

17. The system of claim 11, wherein the policy network is trained to configure routing between the plurality of encoders responsive to a plurality of different domains.

18. The system of claim 17, wherein the target domain is one of a plurality of discrete operational states of a system.

19. The system of claim 11, wherein the computer program further causes the hardware processor to:
detect an anomaly in a system that originates the input time series based on an output of the modular transformer encoder; and
perform an action in the system to correct the anomaly.

20. The system of claim 19, wherein the action is selected from the group consisting of changing parameters of a climate control system to change a temperature or humidity level, engaging a fire suppression system, turning a machine or computer on or off, and changing a configuration of such a computer.
